(19) United States
(12) Patent Application Publication
(10) Pub. No.: US 2011/0246012 A1
(43) Pub. Date: Oct. 6, 2011

(54) INTELLIGENT REGENERATIVE BRAKING UTILIZING ENVIRONMENTAL DATA

(75) Inventor: Jeremy McClain, Oxford, MI (US)

(73) Assignee: CONTINENTAL AUTOMOTIVE SYSTEMS, INC., Auburn Hills, MI (US)

(21) Appl. No.: 13/080,113

(22) Filed: Apr. 5, 2011

Related U.S. Application Data
(60) Provisional application No. 61/320,858, filed on Apr. 5, 2010.

(51) Int. Cl. B60L 7/22

(52) U.S. Cl. 701/22

(57) ABSTRACT

A regenerative braking system for a vehicle includes a control module that receives one or more signals based on a vehicle environment and that generates a set speed and a control signal based on the one or more signals. The control signal represents a motoring mode and a generating mode. A motor control module controls bidirectional current flow between an electric motor and a battery based on the control signal. The motor control module controls the direction and magnitude of the current flow based on the control signal and the electric motor provides a decelerating load that slows an actual speed of the vehicle to the set speed.

### CROSS-REFERENCE TO RELATED APPLICATIONS

This application claims the benefit of U.S. Provisional Application No. 61/320,858, filed on Apr. 5, 2010. The disclosure of the above application is incorporated herein by reference in its entirety.

### FIELD

The present disclosure relates to regenerative braking systems for vehicles.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A modern electric or hybrid electric vehicle may include a regenerative braking system. The regenerative braking system converts the vehicle's kinetic energy to electrical energy in response to the driver pressing a brake pedal. The electrical energy is stored in a battery.

Some electric vehicles and hybrid electric vehicles do not employ regenerative braking systems. These vehicles employ a traditional hydraulic brake system that dissipate the vehicle's kinetic energy as heat.

### SUMMARY

A regenerative braking system for a vehicle includes a control module that receives one or more signals based on a vehicle environment and that generates a set speed and a control signal based on the one or more signals. The control signal represents a motoring mode and a generating mode. A motor control module controls bidirectional current flow between an electric motor and a battery based on the control signal. The motor control module controls the direction and magnitude of the current flow based on the control signal and the electric motor provides a decelerating load that slows an actual speed of the vehicle to the set speed.

A camera generates at least one of the one or more signals based on a perspective in a direction of travel. The control module processes the video signal to parse it for information from road signs. A forward-looking obstacle sensor generates at least one of the one or more signals based on obstacles that are in a roadway ahead of the vehicle. A global positioning system (GPS) receiver provides geographical positioning information to the control module via at least one of the one of more signals. The control module includes a table that represents an intrinsic deceleration rate and an braking deceleration rate that represents braking deceleration performance of the electric motor. The control module generates the control signal based on the table. A hydraulic braking system is actuated by the control module.

A regenerative braking method for a vehicle includes receiving one or more signals based on a vehicle environment and generating a set speed and a control signal based on the one or more signals. The control signal represents a motoring mode and a generating mode. The method controls bidirectional current flow between an electric motor and a battery based on the control signal, controls the direction and magnitude of the current flow based on the control signal, and provides a decelerating load that slows an actual speed of the vehicle to the set speed.

The method includes generating at least one of the one or more signals based on a perspective in a direction of travel and processing the video signal to parse it for information from road signs. The method includes generating at least one of the one or more signals based on obstacles that are in a roadway ahead of the vehicle. The method includes receiving global positioning system (GPS) signals, generating geographical positioning information based on the GPS signals, and communicating the geographical positioning information via at least one of the one of more signals. The method includes comprising generating a table that represents an intrinsic deceleration rate and a braking deceleration rate that represents braking deceleration performance of an electric motor and generating the control signal based on the table. The method includes actuating a hydraulic braking system to facilitate deceleration to the set speed.

A regenerative braking system for a vehicle includes control means for receiving one or more signals based on a vehicle environment and generating a set speed and a control signal based on the one or more signals. The control signal represents a motoring mode and a generating mode. Motor control means control bidirectional current flow between an electric motor and a battery based on the control signal. The motor control means controls the direction and magnitude of the current flow based on the control signal and the electric motor provides a decelerating load that slows an actual speed of the vehicle to the set speed.

The regenerative braking system includes camera means for generating at least one of the one or more signals based on a perspective in a direction of travel. The control means processes the video signal to parse it for information from road signs.

The regenerative braking system includes forward-looking obstacle sensor means for generating at least one of the one or more signals based on obstacles that are in a roadway ahead of the vehicle.

The regenerative braking system includes global positioning system (GPS) receiver means for providing geographical positioning information to the control means via at least one of the one of more signals.

The regenerative braking system includes control means for representing an intrinsic deceleration rate and a braking deceleration rate that represents braking deceleration performance of the electric motor. The control means generates the control signal based on the table means. Hydraulic braking means is actuated by the control means and decelerates a vehicle.

In still other features, the systems and methods described above are implemented by a computer program executed by one or more processors. The computer program can reside on a computer readable medium such as but not limited to memory, non-volatile data storage and/or other suitable tangible storage mediums.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a vehicle that includes a regenerative braking system;

FIG. 2 is a graph of optimal deceleration rate based on battery condition; and

FIGS. 3a-3d are side views of moving vehicles and associated effects on battery state of charge.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

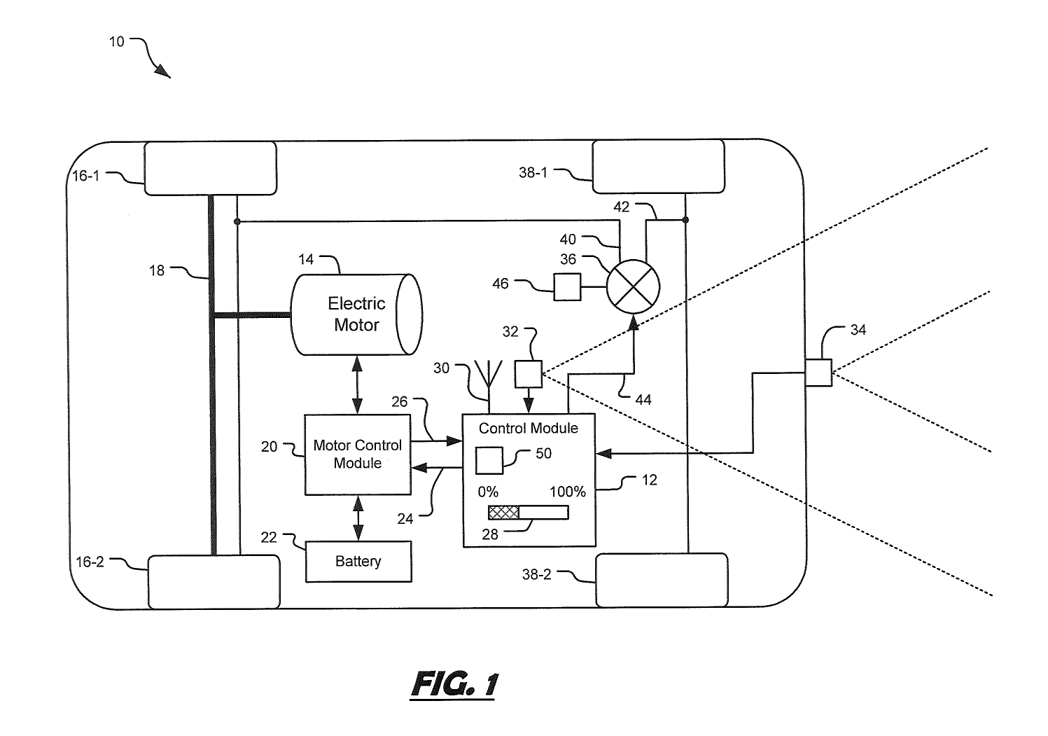

Referring now to FIG. 1, a vehicle 10 is shown. Vehicle 10 includes a control module 12 that controls regenerative braking. An electric motor 14 drives rear wheels 16-1 and 16-2 via a driveline 18. Rear wheels 16-1 and 16-2 are herein referred to collectively as rear wheels 16. A motor control module 20 controls electrical current flow between electric motor 14 and a battery 22. Vehicle 10 provides an extended driving range over electric vehicles of the prior art.

Motor control module 20 operates in at least two modes; a generating mode and a motoring mode. In the generating mode motor control module 20 receives electric current from electric motor 14 and uses the current to charge battery 22. The generating action of electrical motor 14 mechanically loads driveline 18 thereby braking vehicle 10. In the motoring mode motor control module 20 receives electric current from battery 22 and uses the current to power electric motor 14. The motoring action of electrical motor 14 drives driveline 18, thereby propelling vehicle 10.

It should be appreciated by those skilled in the art that electric motor 14 may also comprise a plurality of electric motors that drive associated pairs and/or individual wheels of vehicle 10. It should also be appreciated that driveline 18 may comprise a traditional driveshaft and axle or transaxle arrangement. Driveline 18 may also comprise a direct coupling or a geared coupling between electric motor(s) 14 and one or more of their associated wheels. Electric motor 14 may receive assistance from a gasoline engine (not shown) for propelling vehicle 10.

Motor control module 20 operates in the generating and motoring modes based on a control signal 24. Control module 12 generates control signal 24 based on a plurality of input signals that provide situational information about a driving environment of vehicle 10. The additional signals are described below in more detail. Control module 12 employs the additional signals to determine when vehicle 10 needs to slow down to what degree braking can be effected by regenerative braking vis-a-vis the generating mode. Additional braking can be provided by a hydraulic braking system that is also controlled in part by control module 12. It should be appreciated that control module 12 generates control signal 24 independently of whether a human driver is actuating the hydraulic braking system.

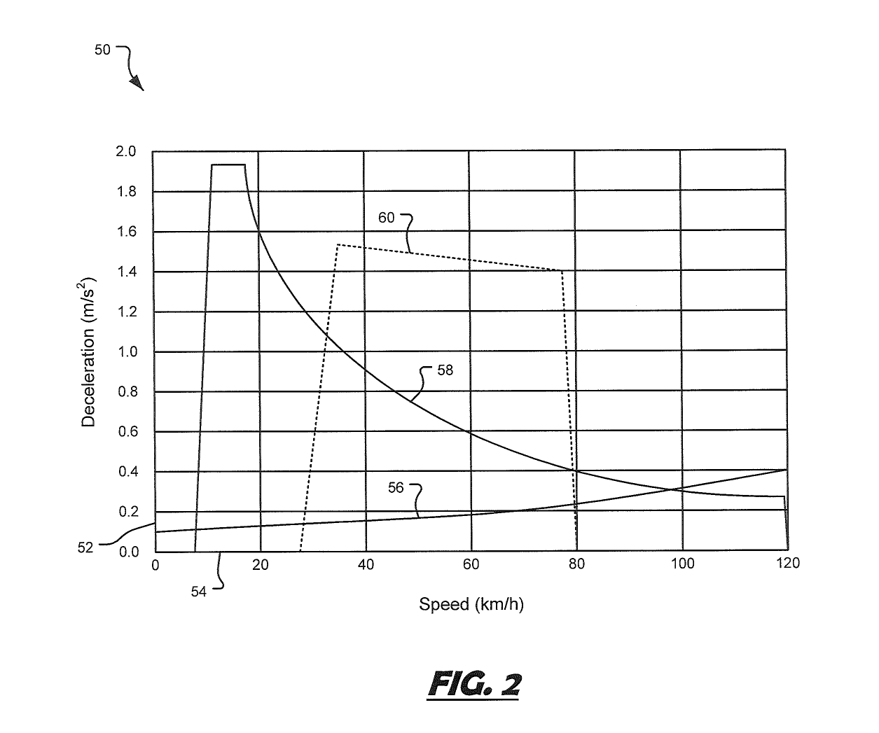

The additional signals that control module 12 receives will now be described. Motor control module 20 generates a feedback signal 26. Feedback signal 26 represents the amount of current that flows in and out of battery 22. Feedback signal 26 may also communicate additional information regarding battery 22 such as its temperature and/or other factors that affect its ability to retain or expend electrical charge. Control module 12 employs feedback signal 26 to maintain one or more memory locations that represent a state of charge 28 of battery 22. Feedback signal 26 may also represent deceleration available by the generating mode as described below in the discussion of FIG. 2.

A global positioning system (GPS) receiver 30 provides geographical positioning information to control module 12. Control module 12 may employ the positioning information in combination with a map database to determine speed limits along the road, road geometry such as inclines, declines, curves and their associated radii, speed limits, and so forth. GPS receiver 30 may also be combined with a receiver that receives weather information transmitted from a satellite and/or terrestrial station. Control module 12 may employ the weather information in combination with one of more of the other signals it receives to calculate a set speed for vehicle 10. The set speed can be calculated periodically, occasionally, and/or upon change of one or more of the signals.

A camera 32 generates a signal based on a perspective in the direction of travel of vehicle 10. Control module 12 and/or camera 32 processes the video signal to parse it for information from road signs. The information relates to speed limits, merge lanes, lane markers and associated radii of upcoming curves, and the like that may also be employed alone or in combination with the other signals to calculate the set speed. It should be appreciated by those skilled in the art that camera 32 may be implemented with a plurality of cameras that generate associated video signals.

A forward-looking obstacle sensor 34 generates a signal based on obstacles, such as other vehicles, road barriers, and the like, that are in the roadway ahead of vehicle 10. Control module 12 processes the signal to determine whether such obstacles exist and if so, their relative velocity with respect to vehicle 10. The relative velocity information may also be employed alone or in combination with the other signals to calculate the set speed and/or to maintain headway to other slower moving traffic.

Control module 12 repeatedly compares the actual speed of vehicle 10 to the calculated set speed. If a comparison shows that vehicle 10 is traveling slower than the set speed then control module 12 takes no further action. On the other hand if the comparison shows that vehicle 10 is travelling faster than the set speed then control module 12 can determine the degree of desired deceleration and/or to anticipate a set speed change, such as with an upcoming roadway speed limit reduction, to utilize regenerative braking capability.

If braking is needed to meet the desired deceleration then control module 12 initiates the braking by instructing motor control module 20 to enter the generating mode. Control signal 24 also communicates the degree of braking required in the generating mode. If control module 12 determines that the amount of braking needed to slow vehicle 10 exceeds the amount of braking that motor control module 20 can provide, then it can also activate a hydraulic brake system. Control module 12 employs a braking profile 50 to determine how much braking motor control module 20 can provide. Braking profile 50 is described below in more detail.

The hydraulic brake system includes a pump 36 that provides braking pressure to first and second braking circuits 40 and 42, respectively. First circuit 40 brakes a pair of wheels such as rear wheels 16. Second circuit 42 provides braking pressure to a pair of front wheels 38-1 and 38-2, referred to collectively as front wheels 38. It should be appreciated that the first and second braking circuits 40, 42 could also be associated with diagonally opposed pairs of front and rear wheels instead of the front/rear arrangement that is depicted. Control module 12 activates pump 36 via a brake signal 44. A brake pedal 46 may also be employed to operate pump 36. Active booster and other actuator types may also be employed in addition to, or instead of, pump 36.

Referring now to FIG. 2, braking profile 50 is shown in more detail. A first axis 52 represents deceleration. A second axis 54 represents vehicle speed of vehicle 10. A first curve 56 shows the intrinsic deceleration of the vehicle 10. For example if vehicle 10 is travelling 100 km/h and then allowed to coast on a level roadway, the deceleration would be a little more than 0.3 m/s². Curve 56 varies according to the design specifics of vehicle 10 and can be experimentally determined.

A second curve 58 represents the amount of braking deceleration that electric motor 14 can provide in the generating mode. Curve 58 also varies according to the design specifics of vehicle 10 and can be experimentally determined.

It should be appreciated by those skilled in the art that one or both of curves 56 and 58 may vary as a function of tire temperature, battery temperature, battery state of charge, battery age and like. As such one or both of curves 56 and 58 may comprise an associated family of curves dependent on a variable other than vehicle speed.

A dotted curve 60 depicts an example deceleration of vehicle 10 when braking decisions are made by a human driver. The driver will tend to allow vehicle 10 to remain at speed longer and then decelerate more rapidly. An area enclosed by curves 58 and 60 represents energy wasted by the human driver's behavior. If the driver allows control module 12 to adjust the speed then curve 58 will provide more efficient regenerative deceleration.

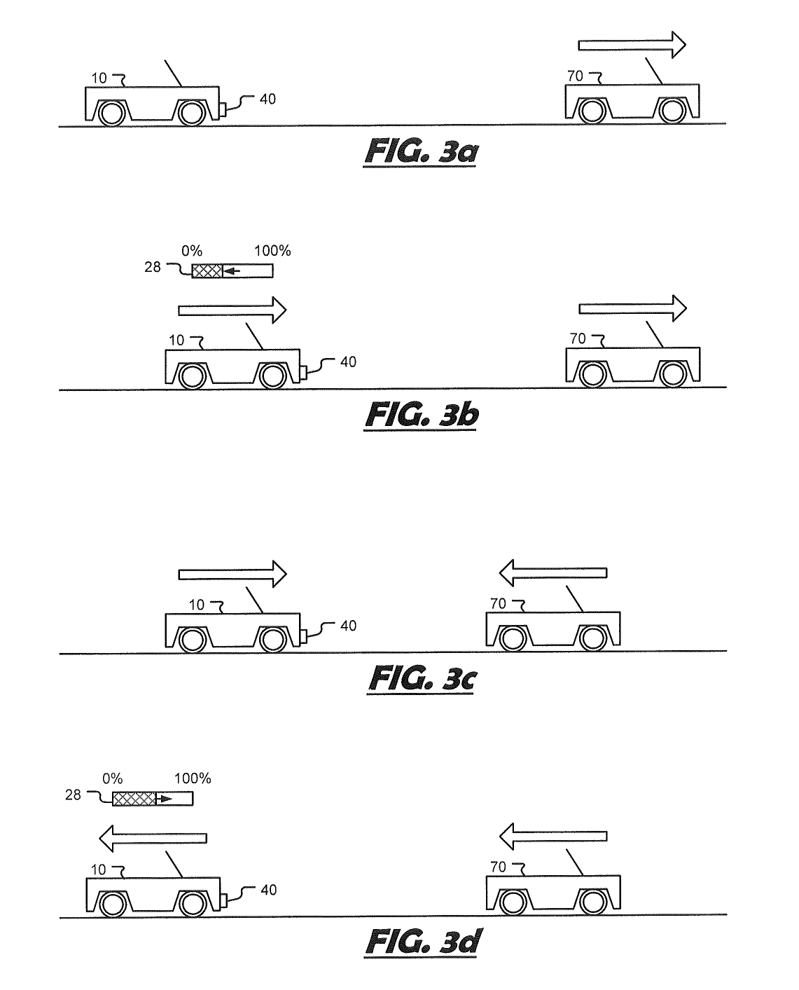

Referring now to FIGS. 3a-3d a series of side views are shown of moving vehicles and associated effects on battery state of charge 26. Beginning with FIG. 3a, vehicle 10 is shown behind a second vehicle 70. Second vehicle 70 is accelerating away from vehicle 10 as depicted by the arrow over second vehicle 70.

In FIG. 3b vehicle 10 begins to accelerate because forward looking sensor 34 indicates that there is enough room to do so. As vehicle 10 accelerates the state of charge 28 decreases.

In FIG. 3c second vehicle 70 is decelerating.

In FIG. 3d vehicle 10 decelerates because forward looking sensor 34 indicates that the distance is decreasing between vehicle 10 and second vehicle 70. As vehicle 10 decelerates electric motor 14 (shown in FIG. 1) charges battery 22 as indicated by state of charge 28.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A regenerative braking system for a vehicle, comprising:
a control module that receives one or more signals based on a vehicle environment and that generates a set speed and a control signal based on the one or more signals and the control signal represents a motoring mode and a generating mode; and
a motor control module that controls bidirectional current flow between an electric motor and a battery based on the control signal, wherein the motor control module controls the direction and magnitude of the current flow based on the control signal and the electric motor provides a decelerating load that slows an actual speed of the vehicle to the set speed.

2. The regenerative braking system of claim 1 further comprising a camera that generates at least one of the one or more signals based on a perspective in a direction of travel and wherein the control module processes the video signal to parse it for information from road signs.

3. The regenerative braking system of claim 1 further comprising a forward-looking obstacle sensor that generates at least one of the one or more signals based on obstacles that are in a roadway ahead of the vehicle.

4. The regenerative braking system of claim 1 further comprising a global positioning system (GPS) receiver that provides geographical positioning information to the control module via at least one of the one of more signals.

5. The regenerative braking system of claim 1 wherein the control module includes a table that represents an intrinsic deceleration rate and an braking deceleration rate that represents braking deceleration performance of the electric motor and wherein the control module generates the control signal based on the table.

6. The regenerative braking system of claim 1 further comprising a hydraulic braking system that is actuated by the control module.

7. A regenerative braking method for a vehicle, comprising:
receiving one or more signals based on a vehicle environment and generating a set speed and a control signal based on the one or more signals wherein the control signal represents a motoring mode and a generating mode;
controlling bidirectional current flow between an electric motor and a battery based on the control signal;
controlling the direction and magnitude of the current flow based on the control signal; and
providing a decelerating load that slows an actual speed of the vehicle to the set speed.

8. The regenerative braking method of claim 7 further comprising generating at least one of the one or more signals based on a perspective in a direction of travel and processing the video signal to parse it for information from road signs.

9. The regenerative braking method of claim 7 further comprising generating at least one of the one or more signals based on obstacles that are in a roadway ahead of the vehicle.

10. The regenerative braking method of claim 7 further comprising receiving global positioning system (GPS) signals, generating geographical positioning information based on the GPS signals, and communicated the geographical positioning information via at least one of the one of more signals.

11. The regenerative braking method of claim 7 further comprising generating a table that represents an intrinsic deceleration rate and a braking deceleration rate that represents braking deceleration performance of an electric motor and generating the control signal based on the table.

12. The regenerative braking method of claim 7 further comprising actuating a hydraulic braking system to facilitate deceleration to the set speed.

13. A regenerative braking system for a vehicle, comprising:
control means for receiving one or more signals based on a vehicle environment and generating a set speed and a control signal based on the one or more signals and the control signal represents a motoring mode and a generating mode; and
motor control means for controlling bidirectional current flow between an electric motor and a battery based on the control signal, wherein the motor control means controls the direction and magnitude of the current flow based on the control signal and the electric motor provides a decelerating load that slows an actual speed of the vehicle to the set speed.

14. The regenerative braking system of claim 13 further comprising camera means for generating at least one of the one or more signals based on a perspective in a direction of travel and wherein the control means processes the video signal to parse it for information from road signs.

15. The regenerative braking system of claim 13 further comprising forward-looking obstacle sensor means for generating at least one of the one or more signals based on obstacles that are in a roadway ahead of the vehicle.

16. The regenerative braking system of claim 13 further comprising global positioning system (GPS) receiver means for providing geographical positioning information to the control means via at least one of the one of more signals.

17. The regenerative braking system of claim 13 wherein the control means includes table means for representing an intrinsic deceleration rate and an braking deceleration rate that represents braking deceleration performance of the electric motor and wherein the control means generates the control signal based on the table means.

18. The regenerative braking system of claim 13 further comprising hydraulic braking means that is actuated by the control means and that decelerates a vehicle.
